(19) United States
(12) Patent Application Publication
(10) Pub. No.: US 2011/0001637 A1
(43) Pub. Date: Jan. 6, 2011

(54) METHOD FOR INDICATING A NOISE LEVEL OF A ROTARY-WING AIRCRAFT

(75) Inventor: Pierre Spiegel, La Salvetat-Saint-Gilles (FR)

Correspondence Address: HAHN LOESER & PARKS, LLP, One GOJO Plaza, Suite 300, AKRON, OH, 44311-1076, US

(73) Assignee: DEUTSCHES ZENTRUM FUR LUFT- UND RAMFAHRT E.V., Koln (DE)

(21) Appl. No.: 12/920,018

(22) PCT Filed: Feb. 18, 2009
(86) PCT No.: PCT/DE09/00215

§ 371 Date: Aug. 27, 2010

(30) Foreign Application Priority Data
Feb. 29, 2008 (DE) 10 2008 012 181.9

(51) Int. Cl. B64D 43/00

(52) U.S. Cl. 340/971

(57) ABSTRACT

A method for displaying a noise level (L_{far field}) of a rotary-wing aircraft (10) and system there for, the method comprising the following steps: (a) detecting a torque (M_{engine}) in a drive train of the rotary-wing aircraft (10), (b) detecting of a forward speed (V_{forward}) of the rotary-wing aircraft (10), (c) determining a noise level of the rotary-wing aircraft (10) from the torque (M_{engine}) or the torque (M_{engine}) and the forward speed (V_{forward}), and (d) providing an indication of the noise level in a cockpit (20) of the rotary-wing aircraft (10).

This application is a national stage application PCT/DE2009/000215, filed Feb. 18, 2009, which claims priority to German Patent Application (DE) 10 2008 012 181.9, filed Feb. 29, 2008.

### BACKGROUND AND SUMMARY OF THE DISCLOSURE

The invention relates to a method for indicating a noise level of a rotary-wing aircraft. A second aspect of the invention relates to a rotary-wing aircraft having a noise indication which is designed to indicate a noise level.

Rotary-wing aircraft noise is an impediment to the widespread use of rotary-wing aircraft since, in civil use, because it disturbs the population and, in military use, it makes it easier to detect the rotary-wing aircraft. In order to provide pilots of rotary-wing aircraft with feedback about the noise produced by the rotary-wing aircraft, it is known from DE 100 22 819 C1 and from the article “Flight experiments for measurement of aircraft noise using “tunnel-in-the-sky” display” by Hirokazu Ishi, National Aerospace Laboratory of Japan RESEARCH PROGRESS 2001, issued by: NATIONAL AEROSPACE LABORATORY OF JAPAN CHOFU, TOKYO, JP (October 2002) pp. 95, 96, ISSN 13405977, for microphones to be provided, for example, on skids on the rotary-wing aircraft. The microphones receive the noise and indicate it in the rotary-wing aircraft cockpit. This has the disadvantage that only the near field noise can be indicated, as caused by the rotary-wing aircraft in the immediate vicinity of the microphone point. The far field noise, which is the important factor from noise protection, can therefore not necessarily be detected since the noise measurement at a number of points close to the rotary-wing aircraft is not representative of the far field noise, because of the strong and variable directional characteristic of the rotor noise.

It is also known for a blade pressure to be measured on the rotors of the rotary-wing aircraft, and for the noise produced by the rotary-wing aircraft to be calculated from this blade pressure, using a mathematical model. This has the disadvantage that data recording from the rotor to the cockpit is complex and susceptible to errors.

DE 100 22 568 A1 discloses a method for measuring noise of a stationary measurement object by means of a helicopter. The helicopter noise itself is not considered there.

DE 32 13 127 C2 discloses a method for measuring the propeller rotation noise when a single-engine aircraft is flying over, but this is not suitable for free use of a rotary-wing aircraft, since a microphone stationed on the ground is provided.

The invention is based on the object of allowing the pilot of the rotary-wing aircraft to estimate the noise produced by the rotary-wing aircraft, particularly in the far field, in a simple manner.

The invention solves the problem by a method of indicating a noise level of a rotary-wing aircraft, having the steps (a) detecting a torque in a drive train of the rotary-wing aircraft, (b) detecting a forward speed and optionally a flight altitude, (c) determining a noise level of the rotary-wing aircraft from the torque and optionally the forward speed, and optionally the flight altitude, and (d) providing an indication of the noise level in a cockpit of the rotary-wing aircraft.

The second aspect of the invention solves the problem by a rotary-wing aircraft of this generic type which has a torque detection apparatus for detecting a torque, wherein the noise indication is designed to indicate a noise level determined from the torque.

The invention has the advantage that it can be incremented easily and cost-effectively. Rotary-wing aircraft generally have a torque detection apparatus. All that is therefore necessary is to determine the noise level from a signal from the torque detection apparatus, and to indicate this in the cockpit. This is possible with little additional hardware complexity.

A further advantage is that existing rotary-wing aircraft can easily be retrofitted. A further advantage of the invention is that the determination of the noise level does not necessitate any distinction between a stationary flight state and a nonstationary flight state. Furthermore, there is no need to take account of a mass of the rotary-wing aircraft, as is generally necessary in existing methods, since the torque to achieve a predetermined flight state is automatically influenced by the mass. Since the noise level is indicated, the pilot can learn to fly with low noise.

A further advantage is that the entire noise scale is always within view of the pilot, as a result of which he not only knows the noise that the rotary-wing aircraft is currently producing but also how he can control the rotary-wing aircraft to make it quieter. Since the torque and the setting of a collective lever for flying the rotary-wing aircraft are highly correlated, the pilot can easily set an advantageous torque.

For the purposes of the present description, a rotary-wing aircraft means, in particular, a helicopter or an aircraft with a tilting rotor. Determining the noise level of the rotary-wing aircraft from the torque means, in particular, that the noise level is derived, for example calculated, from the torque value. However, it is also possible to determine the noise level by displaying the torque value on an appropriate indication apparatus, which is designed such that it allows the noise level to be read directly. The determination of the noise level and the display of the noise level then take place in one process.

If the rotary-wing aircraft has only one engine, the torque means, in particular, the engine torque. If the rotary-wing aircraft has more than one engine, then the torque means, in particular, an equivalent torque which takes account of the torques of all the engines. For example, in this case, the torque is a mean value of all the engines when they are running at the same rotation speed.

It is possible, but not necessary, for the torque to be the only variable which is used to determine the noise level. For example, it is possible to use two, three or more additional operating variables of the rotary-wing aircraft to determine the noise level. However, the torque is the most important operating variable used to determine the noise level. This means, for example, that variation of the torque at 10 points has a greater influence on a change in the determined noise level than a change in another variable at 10 percent.

Displaying the noise level in the cockpit of the rotary-wing aircraft means any way of making a value available to the pilot which allows an indication of the noise which the rotary-wing aircraft is causing. For example, the representation may be a visual representation on an analog or digital indication. Alternatively or additively, the representation may also be an active output of an audible or tactile signal.

A noise indication which is designed to indicate a noise level determined from the torque means, in particular, any apparatus which is designed to determine the noise level from the torque, and to make this available to the pilot by sensory impressions.

The invention is based on the discovery that the noise emitted from the rotary-wing aircraft can be calculated, to a very good approximation, from the torque. This discovery was made by carrying out complex noise measurements on the ground. This is surprising, because the noise emitted by the rotary-wing aircraft is caused by nonlinear processes, for example by the interaction of the rotor blades with air vortices which is being produced by preceding rotor blades. The characteristic of nonlinear processes is that they depend on a multiplicity of influencing factors, which are all relevant at the same time and interact with one another. However, it has been found that, despite this nonlinearity, the torque allows a reliable estimate of the noise.

In one preferred embodiment, the indication is provided by means of a combined torque/noise indication. The pilot can therefore particularly easily read the noise produced by the rotary-wing aircraft.

An indication which can be received particularly quickly is obtained by using a color-coded torque indication. For example, it is possible to identify high noise levels by red, while in contrast low noise levels are indicated by green.

In one preferred embodiment, the method comprises the steps of detection of a forward speed of the rotary-wing aircraft, wherein the noise level of the rotary-wing aircraft is determined from the torque and the forward speed. It has been found that by far the most important two parameters for calculating the noise level are the torque and the forward speed. Since these two variables are used to determine the noise level, an accurate noise level is obtained. The forward speed means, in particular, the forward speed with respect to the surrounding air.

In particular, the noise level is essentially determined exclusively from the torque and the forward speed, and possibly the altitude. This means that additional operating variables may possibly also be included in the calculation of the noise level. A change in the torque of the forward speed by a predetermined percentage value, for example by 10%, results, however, in a greater change in the determined noise level than a change in any other operating variable which is included in the determination and is neither the forward speed nor the altitude, by the same percentage value. In particular, the change in the noise level which is caused by a change in the torque or the forward speed is more than five times as great as that change which is caused by a change in another variable by the same percentage value. A particularly simple calculation is obtained by including only the torque and additionally the forward speed and/or the altitude.

The noise level is indicated particularly intuitively if the noise level is indicated on a two-dimensional indication, as a function of the torque and the forward speed. This can be done, for example, by using a two-dimensional color display on which the appropriate point has a colored coding for each forward speed and for each torque. The colored coding corresponds to the noise of the rotary-wing aircraft. By way of example, those points at which the rotary-wing aircraft causes a particularly high noise level are displayed in red on the display. Torque/forward speed pairs for which the rotary-wing aircraft causes particularly little noise can be displayed in green. The instantaneous state of the rotary-wing aircraft is then represented as a point or cursor on the display. The pilot can then plan his flight memory route to avoid operating states with a high noise load.

An emitted far field noise is preferably displayed as the noise level, which describes the noise produced on the ground by the rotary-wing aircraft. This has the advantage that the value which is displayed to the pilot is that which is particularly relevant for noise protection. He can therefore choose a flight trajectory which, for example, causes a high noise level only when the rotary-wing aircraft is at high altitude, as a result of which the noise load on the ground is low.

The far field noise describes the noise at a predetermined distance which is greater than ten times the rotor diameter from the rotary-wing aircraft, and in all directions which reach the ground. The far field noise then describes the rotary-wing aircraft noise emitted into the far field. In particular, the far field noise means that noise which the rotary-wing aircraft causes directly on the ground. For this purpose, the method may include the step of detection of the altitude of the rotary-wing aircraft, wherein at least the ground noise of the rotary-wing aircraft is displayed as the noise level.

A rotary-wing aircraft according to the invention preferably has an on-board computer which is designed to calculate the noise level from the torque on the basis of a noise emission characteristic. A noise emission characteristic such as this may, for example, be implemented in the form of a family of characteristics stored in a digital memory. The family of characteristics is determined in initial trials. In this case, a multiplicity of flight maneuvers are carried out, and the torque and the noise, for example the far field noise, are measured. A suitable mean-value curve of the dependency of the noise on the torque is determined from a multiplicity of such measurements, and is stored in the family of characteristics.

It is particularly efficient to determine the torque values at the limits of the loud areas. For example, a torque area exists for which loud blade/vortex interaction occurs, and another torque range exists for which a shrouded tail rotor may be loud. The limits depend on the helicopter type.

The electrical control system is designed to compare the torque value with the family of characteristics and to calculate the associated noise level, for example by interpolation.

An improved noise level accuracy is obtained if the rotary-wing aircraft has a forward speed detection apparatus and the on-board computer is designed to calculate the noise level from the torque and the forward speed on the basis of the noise emission characteristic. In this case, the noise emission characteristic may, for example, be in the form of a two-dimensional family of characteristics, in which a noise level is associated with a multiplicity of combinations of torque and forward speed. The on-board computer is then preferably designed to determine the noise level by interpolation from the family of characteristics.

Further improved accuracy of the noise level is obtained if the rotary-wing aircraft has an altitude detection apparatus and the on-board computer is designed to calculate the noise level from the torque, the forward speed and the altitude.

A torque/noise indication which can be read particularly intuitively is obtained by this indication having an analog torque scale and a color-coded noise scale. The noise indication area is preferably arranged radially outside the torque indication area. Alternatively, it is also possible for the torque indication to be a linear indication, with the noise scale being arranged alongside the torque indication.

According to one independent subject, the invention solves the problem by a rotary-wing aircraft which has a pilot assistance system which is designed to indicate to the pilot a nominal torque at which the rotary-wing aircraft emits little noise.

The pilot system preferably comprises a tunnel-in-the-sky system, in which the nominal torque is displayed as well as other nominal operating variables. Nominal operating variables such as these are, for example, a nominal rate of descent and/or a nominal forward speed. The pilot is therefore signaled effectively and intuitively how he can fly with particularly low noise.

### BRIEF DESCRIPTION OF THE DRAWINGS

Exemplary embodiments of the invention will be explained in more detail in the following text with reference to the attached drawings, in which:

FIG. 1 shows a schematic view of a rotary-wing aircraft according to the invention,

FIG. 2a shows a schematic illustration of a torque/noise indication for a rotary-wing aircraft according to the invention,

FIG. 2b shows a schematic illustration of a further embodiment of a torque/noise indication for a rotary-wing aircraft according to the invention,

FIG. 3a shows a forward speed/torque/noise indication for a rotary-wing aircraft according to the invention, and

FIG. 3b shows an alternative embodiment of a forward speed/torque/noise indication with a simplified display.

### DETAILED DESCRIPTION OF THE DRAWINGS

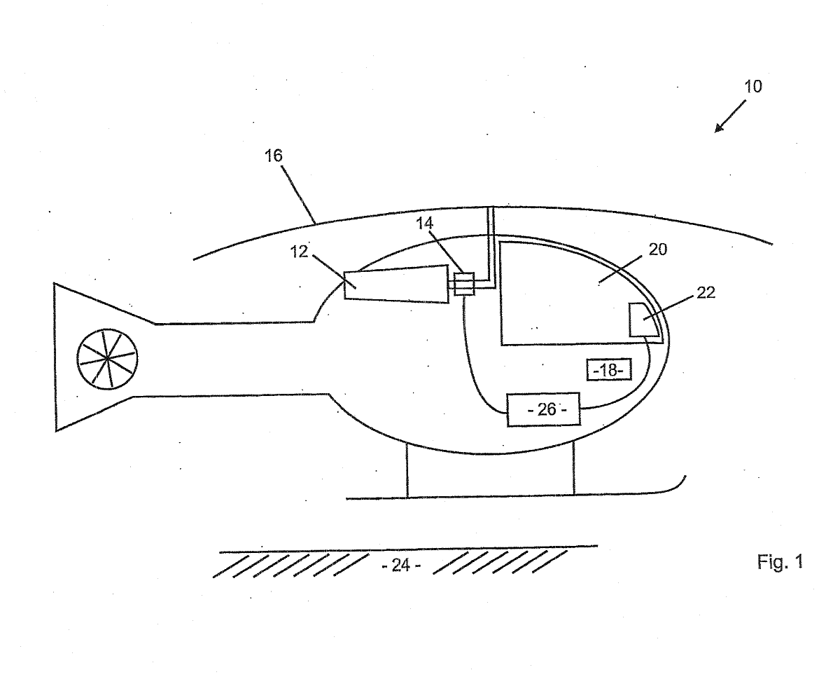

FIG. 1 shows a rotary-wing aircraft 10 in the form of a helicopter having an engine 12, a torque detection apparatus 14 for detection of a torque of the engine 12, and a rotor 16. The engine 12 drives the rotor 16 via a gearbox, which is not shown. The rotary-wing aircraft 10 furthermore has a speed determination apparatus 18 for detection of a forward speed V_{forward} of the rotary-wing aircraft 10.

A noise indication 22 is arranged in a cockpit 20 of the rotary-wing aircraft 10 and provides a pilot with a visual signal of the noise caused by the rotary-wing aircraft 10 on the ground 24. By way of example, the noise indication 22 may have a scale in dB(A) (noise level with A assessment, averaged over an area). The noise indication 22 is connected to an on-board computer 26, which is itself connected to the torque detection apparatus 14.

During operation of the rotary-wing aircraft 10, the torque detection apparatus 14 continually detects a torque, for example at time intervals of 100 ms, in the form of an engine torque M_{engine}. By way of example, it is alternatively possible to measure a rotor torque, as well. The engine torque M_{engine} exists in a drive train between the engine 12 and the rotor 16. The on-board computer 26 uses the engine torque M_{engine} to determine a noise level, for example a level for the far field noise L_{far field}, and displays this on the noise indication 22. To do this, the on-board computer interpolates a noise emission characteristic which is stored in a digital computer. The noise emission characteristic is a tabulated function L_{far field}(M_{engine}) which associates engine torques M_{engine} with the associated far field noise L_{far field}. The noise emission characteristic is determined empirically in initial trials.

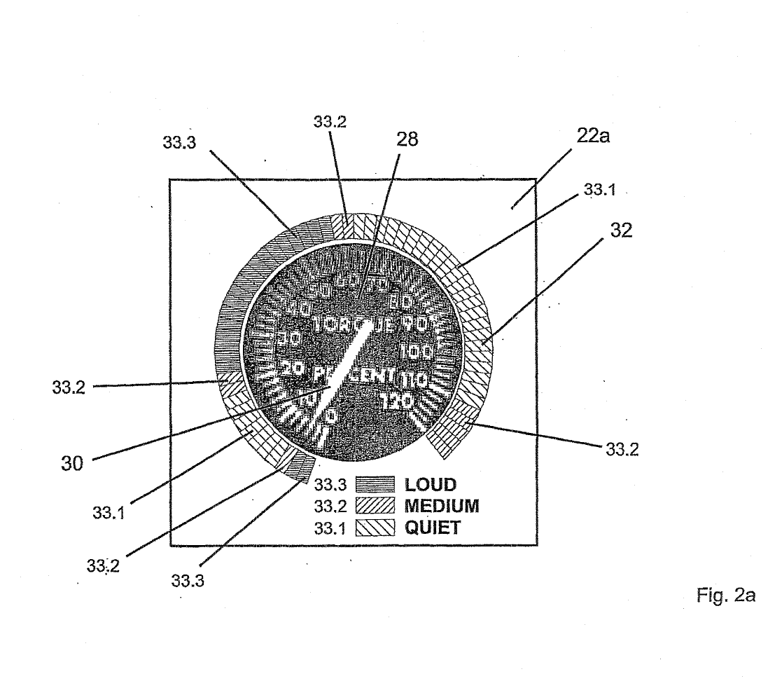

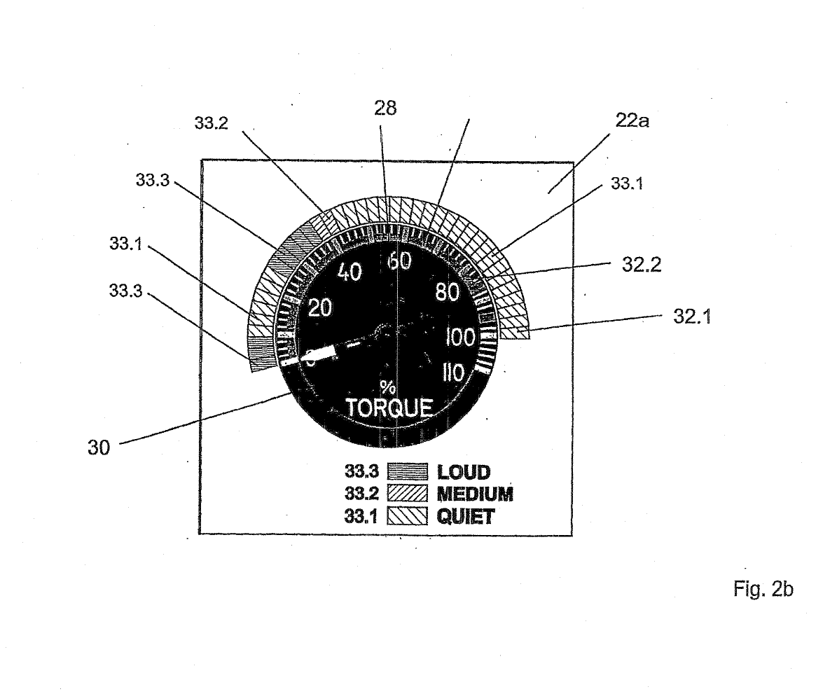

FIG. 2a shows an alternative embodiment of the noise indication in the form of a combined torque/noise indication 22a, which at the same time indicates the torque and the far field noise L_{far field}. The torque/noise indication 22a has a torque scale 28 on which a pointer 30 indicates the engine torque M_{engine} as a percentage of the maximum engine torque M_{engine}, max. The pilot can therefore immediately see how he can vary the torque by means of a collective lever, which is not shown, in order to fly particularly quietly. This is impossible with an indication which indicates only the instantaneous noise.

The torque/noise indication 22a is a rotating pointer instrument and has a color-coded noise scale 32 radially outside the torque scale 28, which noise scale 32 codes the far field noise L_{far field} into a plurality of colors, specifically three colors, 33.1, 33.2, 33.3. On the noise scale 32, those torques are marked with the color 33.1 (green) at which the rotary-wing aircraft 10 develops little noise, torques are marked with the color 33.2 (orange) at which the rotary-wing aircraft 10 develops a medium noise level, and those torques for which the rotary-wing aircraft 10 develops a high noise level are marked with the color 33.3 (red). The torque/noise indication 22a may also be a display on a pilot display screen and/or a linear display.

In the embodiment shown in FIG. 2, the noise level L_{far field} is determined from the engine torque M_{engine} by the pointer 30 pointing at the appropriate value on the noise scale 32, and therefore displaying it at the same time. As can be seen the rotary-wing aircraft causes noise particularly in the medium torque range (rotor noise) and in the very low torque range (shrouded tail rotor noise). The rotation speed of the engine and therefore of the rotor are in general kept constant.

FIG. 2b shows an illustration of a second embodiment of a torque/noise indication 22a with two color-coded noise scales 32.1, 32.2, which are associated with different forward speeds V_{forward}. The first noise scale 32.1 is, in the present case, arranged radially outside the torque scale 28 and applies, for example, to high forward speeds V_{forward}. The second noise scale 32.2 is arranged radially inside the torque scale 28 and applies to low forward speeds V_{forward}.

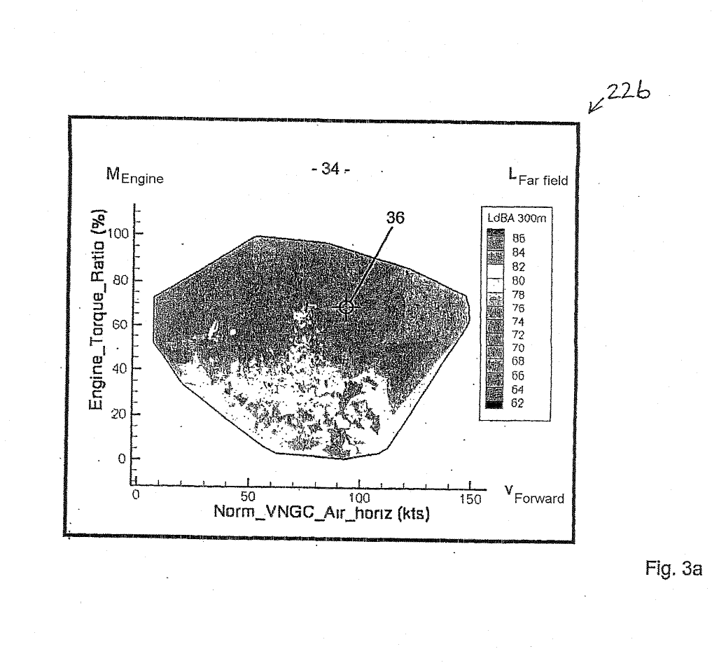

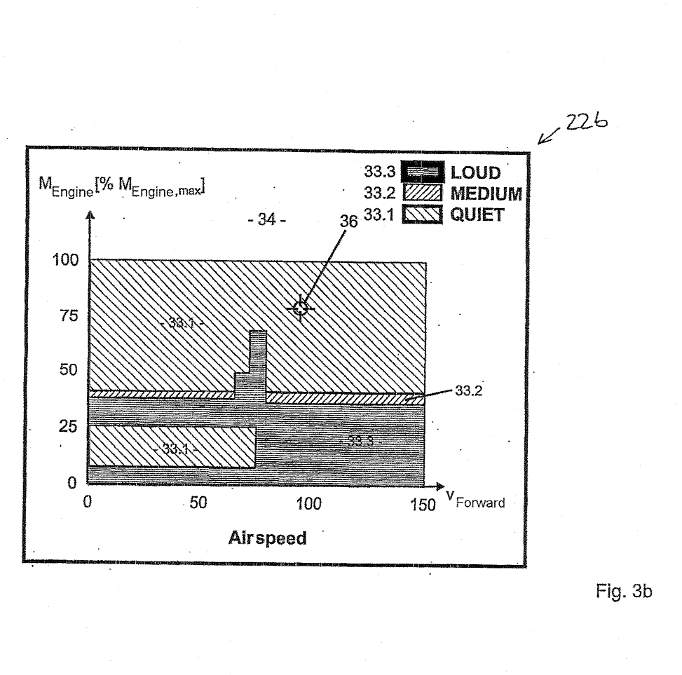

FIG. 3a shows an alternative embodiment of a noise indication in the form of a combined forward speed/torque/noise indication 22b. This comprises a display 34 on which a color which codes the far field noise L_{far field} is displayed for each pair of engine torque M_{engine} and forward speed V_{forward}. The instantaneous state of the rotary-wing aircraft 10 is represented by a cursor 36.

FIG. 3b shows an alternative embodiment of the forward speed/torque/noise indication 22b, which is simplified. A pilot of the rotary-wing aircraft 10 can, for example, now plan an approach trajectory to a predetermined destination on the basis of the indication 22b, so as to cause as little noise as possible on the ground.

The rotary-wing aircraft 10 (FIG. 1) furthermore has a pilot assistance system which runs on the on-board computer 26, in which a plurality of configured minimized-noise approach trajectories are stored for the approach to a predeterminable destination. The pilot can preset a destination for the pilot assistance system, following which the pilot assistance system calculates an approach trajectory which causes as little noise as possible on the ground. Since, as stated above, medium torques produce a particularly high noise level, the approach trajectory is chosen, for example, such that the approach to the destination is initially flown at a high forward speed, and then the torque is greatly reduced, thus initiating a descending flight with a high rate of descent. The medium torque range is therefore passed through quickly, reducing the noise developed.

### LIST OF REFERENCE SYMBOLS

10 Rotary-wing aircraft
12 Engine
14 Torque detection apparatus
16 Rotor
18 Speed determination apparatus
20 Cockpit
22 Noise indication
22a Torque/noise indication
22b Forward speed/torque/noise indication
24 Ground
26 On-board computer
28 Torque scale
30 Pointer
32 Noise scale
34 Display
V_{forward} Forward speed
M_{engine} Engine torque
L_{far field} Far field noise

1-15. (canceled)

16. A method for displaying a noise level (L_{far field}) of a rotary-wing aircraft (10), having the following steps:
(a) detecting a torque (M_{engine}) in a drive train of the rotary-wing aircraft (10),
(b) detecting a forward speed (V_{forward}) of the rotary-wing aircraft (10),
(c) determining a noise level of the rotary-wing aircraft (10) from the torque (M_{engine}) and optionally the forward speed (V_{forward}), and
(d) providing an indication of the noise level in a cockpit (20) of the rotary-wing aircraft (10).

17. The method as claimed in claim 16, where the indication is provided by a combined torque/noise indication (22a, 22b).

18. The method as claimed in claim 16, where the indication is provided by a color-coded noise indication (22, 22a, 22b).

19. The method as claimed in claim 16, where the determination of the noise level (L_{far field}) of the rotary-wing aircraft (10) is exclusively from the torque (M_{engine}).

20. The method as claimed in claim 19, where the noise level (L_{far field}) is indicated in a two-dimensional forward-speed/torque/noise indication (22b) as a function of the torque (M_{engine}) and the forward speed (V_{forward}).

21. The method as claimed in claim 16, where the noise level is a far field noise (L_{iar field}) that describes the noise produced by the rotary-wing aircraft (10) on the ground (24).

22. A rotary-wing aircraft (10) having
(a) a noise indication (22) designed to indicate a noise level (L_{far field}),
(b) a torque detection apparatus (14) adapted to detect a torque (M_{engine}) in a drive train, wherein
(c) the noise indication (22) is adapted to indicate a noise level (L_{far field}) determined essentially from the torque (M_{engine}).

23. The rotary-wing aircraft (10) as claimed in claim 22, further comprising
an on-board computer (26) adapted to calculate the noise level (L_{far field}) from the torque (M_{engine}) on the basis of a noise emission characteristic (L_{far field}(M_{engine})).

24. The rotary-wing aircraft (10) as claimed in claim 23, further comprising a forward speed detection apparatus (18), and where the on-board computer (26) is adapted to calculate the noise level (L_{far field}) from the torque (M_{engine}) and the forward speed (V_{forward}) on the basis of the noise emission characteristic (L_{far field}(M_{engine},V_{forward}).

25. The rotary-wing aircraft (10) as claimed in claim 22, where the noise indication (22) is a combined torque/noise indication (22a).

26. The rotary-wing aircraft (10) as claimed in claim 22, where the noise indication (22) is a color-coded noise indication (22).

27. The rotary-wing aircraft (10) as claimed in claim 22, where
the torque/noise indication (22a) comprises an analog torque scale (28) and a color-coded noise scale (32), and
the noise scale (32) is arranged radially outside the torque scale (28).

28. The rotary-wing aircraft (10) as claimed in claim 22, where the torque detection apparatus (14) is adapted to detect an engine torque (M_{engine}).

29. The rotary-wing aircraft (10) as claimed in claim 22, further comprising a pilot assistance system adapted to indicate to the pilot a nominal torque at which the rotary-wing aircraft emits reduced noise.

30. The rotary-wing aircraft as claimed in claim 29, where the pilot system comprises a tunnel-in-the-sky system wherein the nominal torque is indicated together with other nominal operating variables.
